(19) United States
(12) Patent Application Publication
(10) Pub. No.: US 2011/0078030 A1
(43) Pub. Date: Mar. 31, 2011

(54) WEBSITE WITH ACTIVITIES TRIGGERED BY CLICKABLE ADS

(75) Inventors: Karl Joseph Borst, Toronto (CA); Stephen Braund, Woodbridge (CA)

(73) Assignee: GANZ, Woodbridge (CA)

(21) Appl. No.: 12/893,430

(22) Filed: Sep. 29, 2010

Related U.S. Application Data
(60) Provisional application No. 61/246,826, filed on Sep. 29, 2009.

(51) Int. Cl. G06Q 30/00

(52) U.S. Cl. 705/14.73

(57) ABSTRACT

A website stores a user account with information indicative of items associated with a website user. Those items are usable on the website. The website displays a virtual world and accepts inputs which allow interacting with the virtual world. An advertisement is produced. At only some times, the selection of that advertisement is entitled to additional content. The additional content can include an additional item usable on the website. The user therefore has some statistical chance of getting that additional item when they click on the site.

This application claim priority from provisional application No. 61/246,826, filed Sep. 29, 2009, the entire contents of which are herewith incorporated by reference.

### BACKGROUND

Websites have been used to create virtual worlds and display the contents of those virtual worlds to users. The virtual world may be displayed to include a user's individual items such as characters, and special items that are used, e.g., worn or otherwise interacted with, for those characters, all associated together.

A virtual world can be implemented on any suitable website including a graphical chat room and/or a virtual world, such as the one described in U.S. Patent Application Publication No. 2005/0177428 A1 to Ganz, which is incorporated by reference in its entirety herein. This website defines a system where there is a product that is sold; that product has a hidden code on the product, and the code is entered into a website to create a virtual representation of the product on the website.

### SUMMARY

Many of these websites may be supported by advertising. It is desirable to find ways to get users to view the advertising.

One aspect relates to displaying advertising (an “ad”) on a website that a user can view and select. Most or some of the time, clicking on the ad will trigger a pop-up giving more detail about the ad/promotion. However, there is also a probabilistic chance that the user will trigger an activity that will allow the user to search for unique virtual or real prizes on the website. The prizes are tied into the content of the ad.

In one embodiment, the content is a movie and the prizes are tied to the content of the movie.

### BRIEF DESCRIPTION OF THE DRAWINGS

In the Drawings:

FIG. 1 shows a screenshot of a virtual world with virtual pet, virtual world, furniture, and things to do;

FIG. 2 shows a page which shows different virtual pets which are owned/and information about those pets;

FIG. 3 shows a user-operation page, which allows turning on and off third party ads;

FIG. 4 shows the clickable ad;

FIG. 5 shows a static ad pop up;

FIG. 6 shows a game popup screen;

FIG. 7 shows the specific game that is executed via the game popup screen;

FIG. 8 shows the prize that has a tie-in to the game;

FIG. 9 shows a congratulatory screen

FIG. 10 shows the exit screen; and

FIG. 11 shows a flowchart of operation

FIG. 12 shows a schematic block diagram of an embodiment of the system and its interactions with some external entities;

FIG. 13 shows a schematic diagram of an embodiment of hardware implementation.

### DETAILED DESCRIPTION

Our previous issued U.S. Pat. Nos. 7,465,212, 7,442,108 and 7,425,169, the entire contents of which are herewith incorporated by reference, describe a system which uses a real or tangible item to present a corresponding virtual item on a website; where the real item and the virtual item look similar to one another. In that application, a tangible item is packaged with a code, and that code is later used to register the virtual item. After registration of the code, a virtual representation of the tangible item is created into the Internet virtual world. The website hosts a user account that stores information indicative of the registered items that have been registered in this way.

In some embodiments, the code that is packaged with a product can be a unique registration number provided with the product at purchase, where the registration number is typically hidden from view until after purchase or use of the product.

The virtual representation that is shown on the virtual world may be a replica of the actual item—e.g. similar to, a cartoonized version, or otherwise recognizable as a replica of the actual item. Users buy items, toys for example, in a tangible form, and some part of the packaging of the tangible toy has the code. For example, the toy may have a tag that is hidden in a special way to avoid access to the code prior to purchase of the toy. Opening that hidden tag reveals the registration code.

The code can be entered into a website to register the toy. For example, the website can have a computer that looks up the code, providing a virtual representation of the specific product which has been purchased. The website also hosts a virtual world, and allows the user to enter a virtual world in which the user can interact with a virtual version of the product that the user has purchased. For example, if a user buys a toy stuffed monkey, the monkey is packaged with a code that is looked up by the computer, allows entering the code to enter the virtual world with a virtual version of that specific monkey.

The users can get other codes to unlock other items within the virtual world, such as, for example, by purchasing additional products/accessories (real or virtual) or as a prize for playing a game (real or virtual). For example, clothing, room furnishings, or other items for use with the user's already unlocked toys can be obtained in these ways, among others.

An online “virtual world” is described where the user of a product can register the product and then interact with the virtual version of the product. For example, a user of a toy can register the toy using a unique registration number provided with the toy at purchase, adopt the toy online, and play/interact with a virtual representation of the toy (the “virtual toy) in the virtual world.

In some embodiments, the “virtual world” can be implemented using an interactive website via a user computer connected to the Internet. In this manner, a user can play/interact with the virtual toy in a computer generated fantasy world (i.e., the virtual world).

The term “toy” could be any type of toy (for example, those used by a child), including, for example, plush toys (including but not limited to stuffed animals, fantasy figures, dinosaurs, vehicles, dolls, etc.), along with other types of toys (including, but not limited to, vehicles such as cars and trucks; action figures such as army figures, monsters, sports figures, fantasy figures, dinosaurs; and dolls, etc.).

Graphics, animation, sound, and recorded or live images might be utilized to generate the virtual world and the virtual toy. In addition, other sources of material can also be utilized. In essence, the virtual world creates an interactive playland for the toy owner to encourage imagination using the toy, and at the same time, provide an incentive to purchase additional toys or encourage additional individuals to also purchase toys in order to participate in the Entertainment System.

Throughout this disclosure, the term “virtual” is used, for example, to describe the user viewable/hearable material presented to the user on the user computer from data and/or computer programs and commands generated and/or provided by the Entertainment System, to the user computer running one or more computer applications (e.g., a web browser with the appropriate plug-ins, applets, and/or other support programs, etc.). The System provides the data and/or programs, via a communication network connected to the System and the user computer (e.g., the Internet). The term “virtual” does not necessarily mean that the displayed item is not “real”, because the displayed item could, for example, be a video or picture of a real item, for example. Furthermore, the “virtual world” is presented using “real” physical phenomena (e.g., light and sound), and is impacted by “real” user interactions (e.g., mouse and keyboard manipulations). Rather, the term “virtual” is used to describe the computer generated and/or provided presentation to the user, including both visual and audible effects, via the user computer. It is a “virtual world” in the sense that it is primarily a computer presented fantasy world with which the user can interact via manipulations of the user computer. In this manner, the “virtual” items of the virtual world can be presented as interacting with each other and with the user.

A virtual world allows advertising by advertisers, such as by the virtual world itself, or by third party advertisers. These advertisements can be used, for example to provide revenue to the website. Advertisers can target the specific audience of the virtual world, or of any character, or room, or area in the virtual world.

In the embodiment used in Ganz' WEBKINZ® website, for example, the user is a child. An embodiment allows parents to disable any third party advertisements to the child. The embodiments address this by providing those interested users or parents of users with the ability to modify, e.g., disable, third party advertisements.

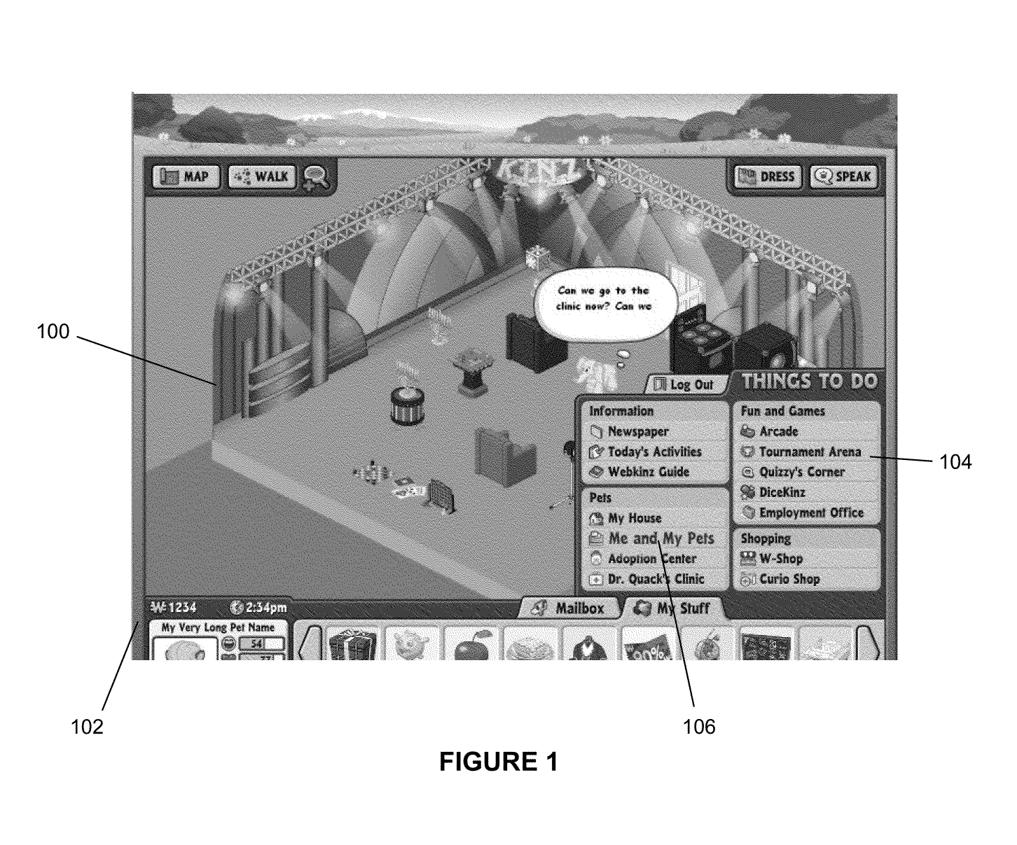

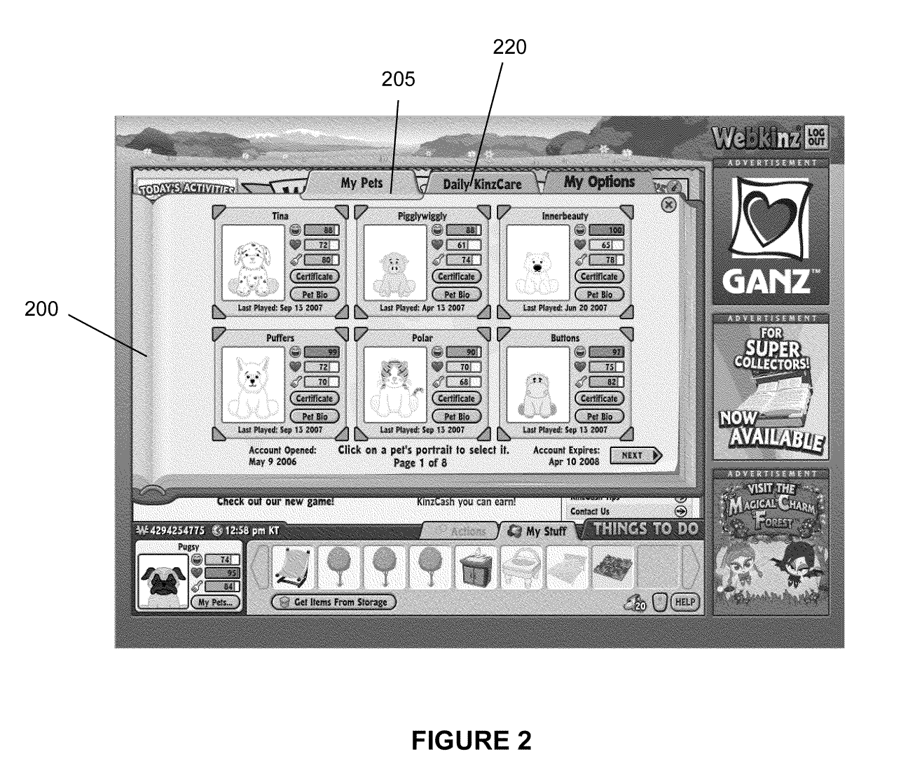

In an embodiment, the interactive experience includes a private room 100 for the interaction. FIG. 1 shows an embodiment in which the user has access to a control menu from the dock 102. FIG. 1 depicts an embodiment wherein a gateway access point is accessible through the “THINGS TO DO” menu 104. One option is the submenu “ME AND MY PETS” 106 which navigates to the “ME AND MY PETS” page 200 shown in FIG. 2. This includes the ability to interact with the user's pets via tabbed pages. A first “my pets” page 205 is as shown in FIG. 2, associated with the “my pets” tab 210. A daily KinzCare tab 220 can describe the kinds of actions that should or can be taken. In the present embodiment, the user may navigate from the “ME AND MY PETS” page 200 to a subsequent menu, by selecting the “MY OPTIONS” tab 202.

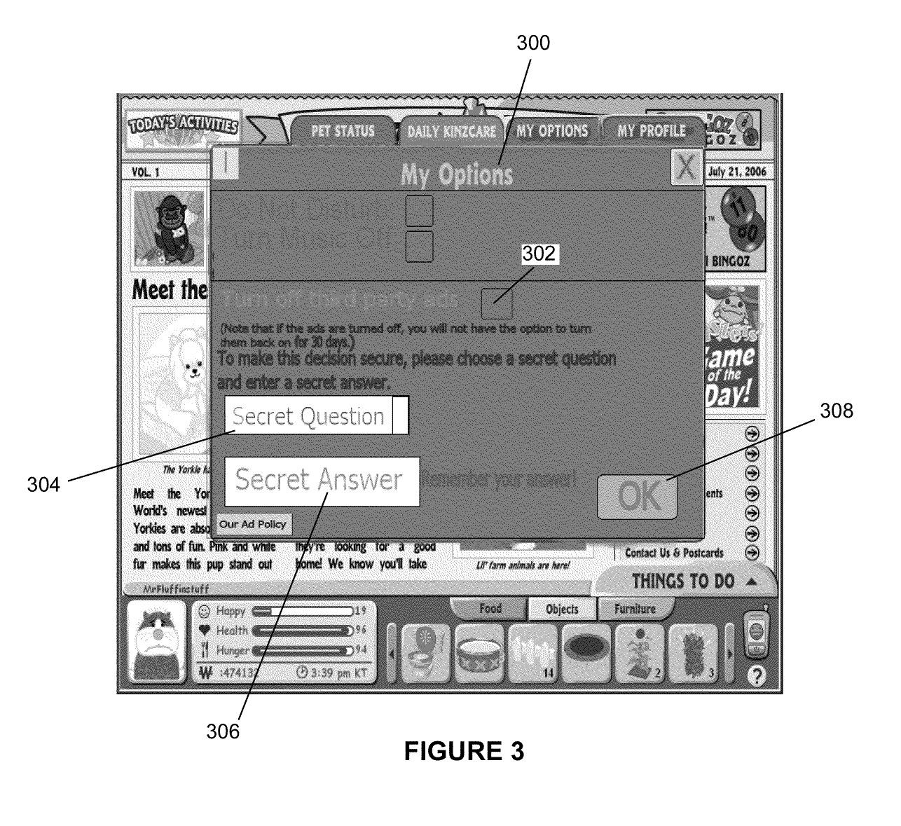

Selection of the “MY OPTIONS” tab 202 navigates the user to the “MY OPTIONS” page 300 shown in FIG. 3. The “MY OPTIONS” page 300, provides a user, e.g., child or parent, with the ability to disable any third party advertisements. Should the user wish to disable or “turn off third party ads”, the user is prompted to select the check box 302. Once that check box 302 has been selected and the user selects the OK button 308, the third party advertisements are effectively disabled.

As a further alternative embodiment, once the third party advertisements have been deactivated, internal advertisements from the virtual world hosting organization may take the place of the third party advertisements. These advertisements may optionally describe other toy offerings, such as a pet of the month, related product offerings (clothing, games etc), upcoming products, upcoming events, and additional games and services to which the users may avail themselves.

In one embodiment, the ability to turn off third party ads is limited to members who have paid active accounts. Free accounts and expired accounts will not provide the ability to turn the ads off. This option will be inactive for those account holders.

According to an embodiment, users are encouraged to leave the ads running. In an embodiment, users who have chosen to view third party ads on the site get special opportunities related to those ads.

According to one embodiment, certain ads have premium content. The premium content can include bonuses, such as prizes which can include, for example, virtual items for use on the website, as well as real items that can be delivered to users. The premium content, however, is not always provided to the user. A rule is defined probabilistically in one embodiment. In another embodiment, the rule operates randomly or by some regular or irregular interval, for example, which defines how often the content is provided to the user.

In an example embodiment described herein, the content is provided to a requesting user some times (but not always). One embodiment of a new release, here Walt Disney's upcoming release of the “Diamond Edition” for Snow White and the Seven Dwarfs is described. In this embodiment, there may be ads for the upcoming release of the Diamond Edition.

An advertisement is shown (such as an advertising banner, for example), which has selectable portions, for example areas on the graphical user interface that can be clicked on by a user. Most of the time, clicking on the ad will only trigger a pop-up giving more detail about the promotion. However, based on a probabilistic rule or some other methodology, some but not all users will receive premium content when they click on the ad. The user receiving the premium content gets special opportunities as described herein.

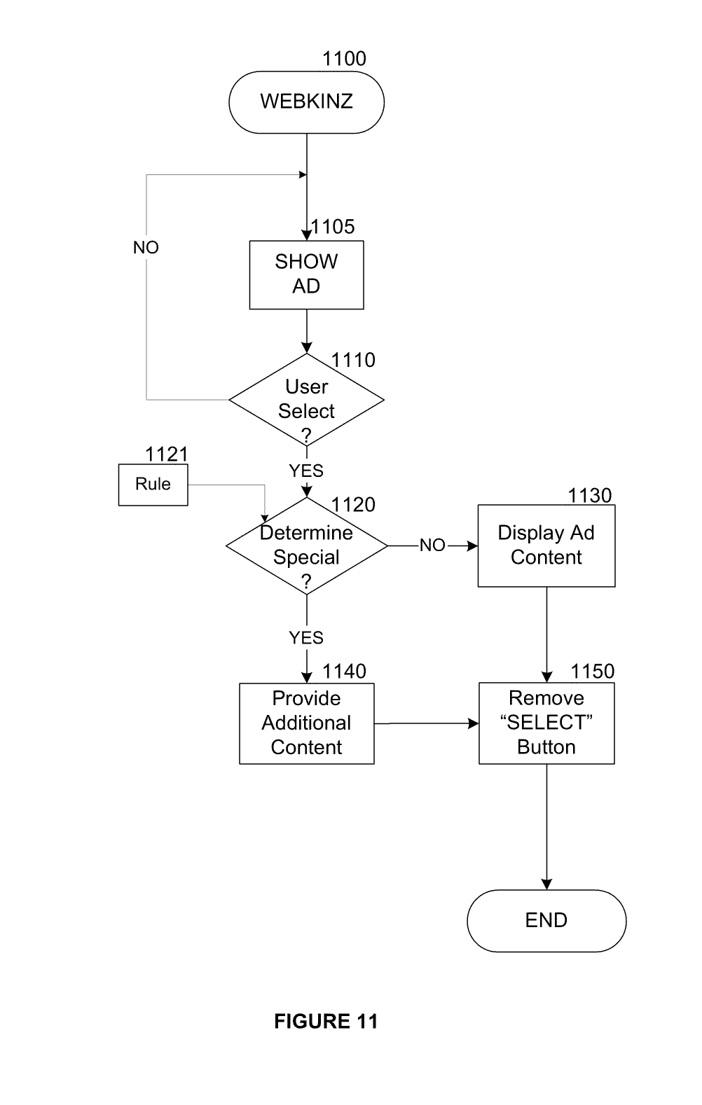

FIG. 11 illustrates a flowchart which is implemented by a computer executing software that carries out many of the functions of this system. The computer can be a server computer or client computer (such as is described below in more detail). In this embodiment, the operations are carried out on a server computer including a web server and executing custom software for implementing the functions and that serves content to a user computer over the Internet.

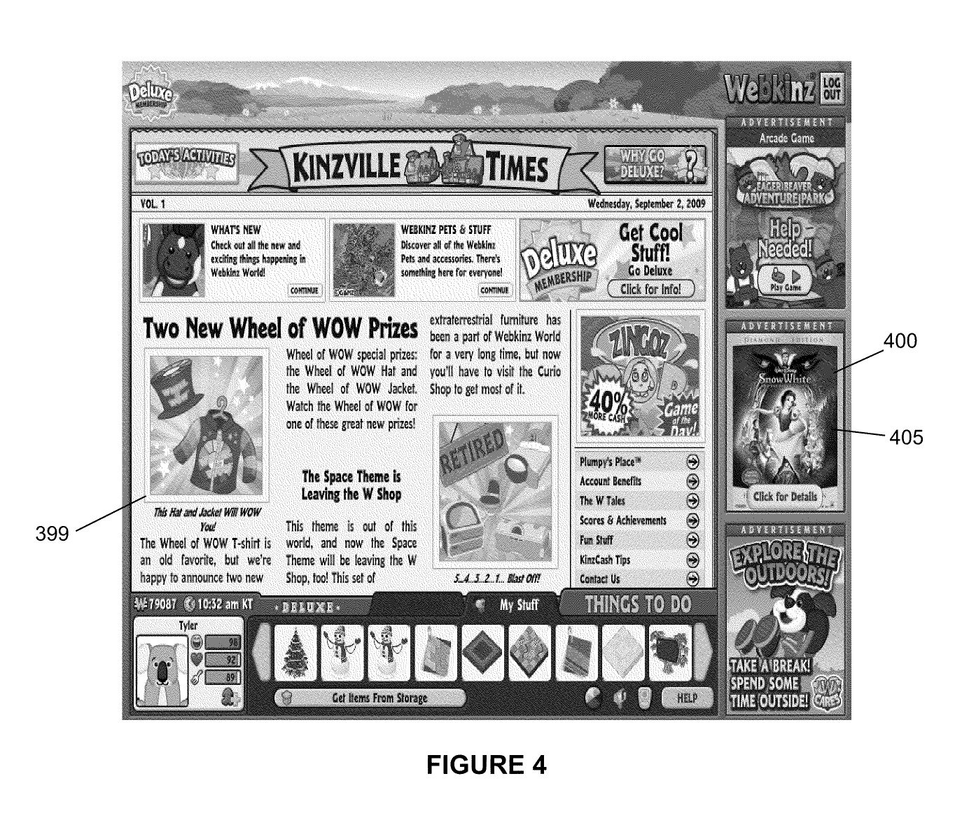

At 1100, the system operates the Webkinz website, according to the systems described in our above referenced patents. Part of this website 1105 shows an ad, such as the advertisement 400 shown in FIG. 4 and others. 1110 represents the user selection of the ad, which may be a selection by the user on the remote client that is a user computer connected to the Internet, which creates a signal that is sent over the Internet to the server. Based on the user selection being detected at 1110, a determination of whether this interaction is one which will receive special or additional content is determined at 1120. This determines whether the user is one of the special users who will receive special content as part of the ad results.

If the user is not one of the special users who will receive the special content, the system displays the conventional ad content at 1130 and provides information about the advertised product to the user in the normal fashion when the user clicks on the ad.

If the user is determined to be special at 1120, the system displays additional content at 1140. As described herein, this additional content provides at least one opportunity for the user to obtain a bonus, such as a special item that is related to the ad, for example. That special item is received either in the real world (such as by delivering the item to the user at the user address, for example) or the virtual world (such as providing an additional virtual item, for example, or providing a video or access to a special feature in the website) which is not provided to users who are not determined special and thereby simply receive the display of the ad at 1130.

In this embodiment, 1120 operates probabilistically based on a rule 1121 which specifies a criteria that provides a percentage of selection. For example, the rule 1121 could select every tenth ad selection by any user as being an ad that is entitled to additional content. Alternatively, the rule can operate according to a random function, e.g., a pseudorandom number generator. In this case, the rule would select the additional content when the pseudorandom number matches the specified criterion. In the Webkinz embodiment, the user who receives the additional content obtains unique Webkinz prizes that are usable on the Webkinz website, but are tied into the movie ad, for example. Only users who are randomly selected in this way can actually participate in the activity that can lead to getting these prizes. Thus, users are encouraged to click on ads in order to see if they are selected to receive the additional bonus content, but the system can efficiently operate by not having to provide the bonus content to all users every time they click on the ads.

FIG. 4 shows the Webkinz® page 399 with its different things to do. One aspect is a clickable ad 400, shown as 1105 in the FIG. 11 flowchart. The ad in 400 is an ad for the video Snow White and the seven dwarves. One portion of that ad is a selectable button entitled “click for details”.

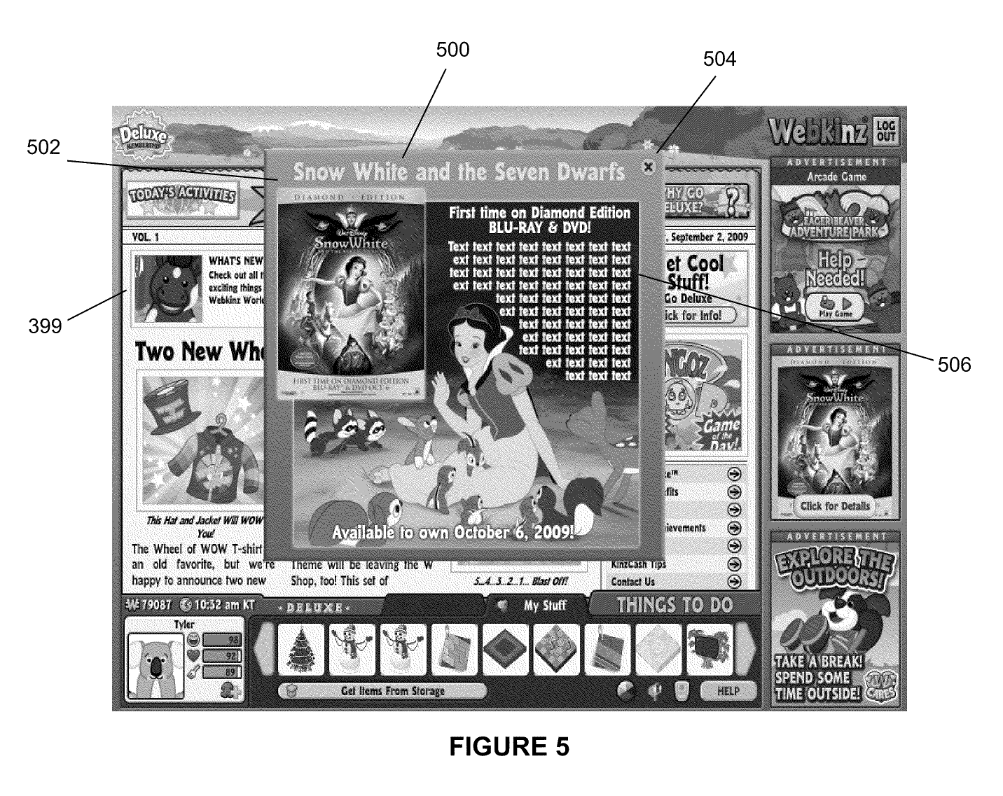

The click for details button opens a detailed screen shown as 500 in FIG. 5 providing a static ad pop-up. The static ad pop-up opens over the basic content window 399. The pop-up ad includes a title section 502 and close button 504 as conventional. The ad header 506 and body text shows the different text that is part of the advertisement itself, providing information about the video to the user and information about its available and potential for purchase, for example.

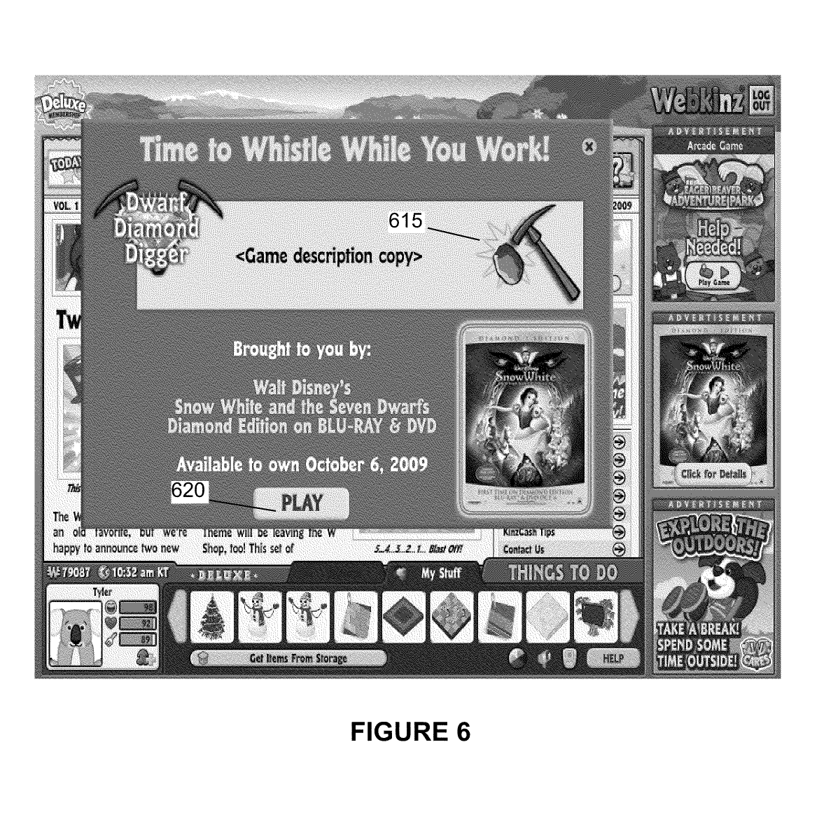

At 1140 in FIG. 11, instead of receiving the pop-up static ad with additional material as in FIG. 5, the user is provided with a game interface that is related to the advertisement. An example of the special interface from 1140 is shown in FIG. 6. In this embodiment, the user gets a chance to play the “Dwarf Diamond Digger” game interface shown in FIG. 6. A game loader window with header text including the logo and description copy as well as the movie promotional image 602 is shown. In this game, the “whistle while you work” theme (a theme from the movie being advertised) is used to allow a user to carry out a game related to the movie, here mining for items.

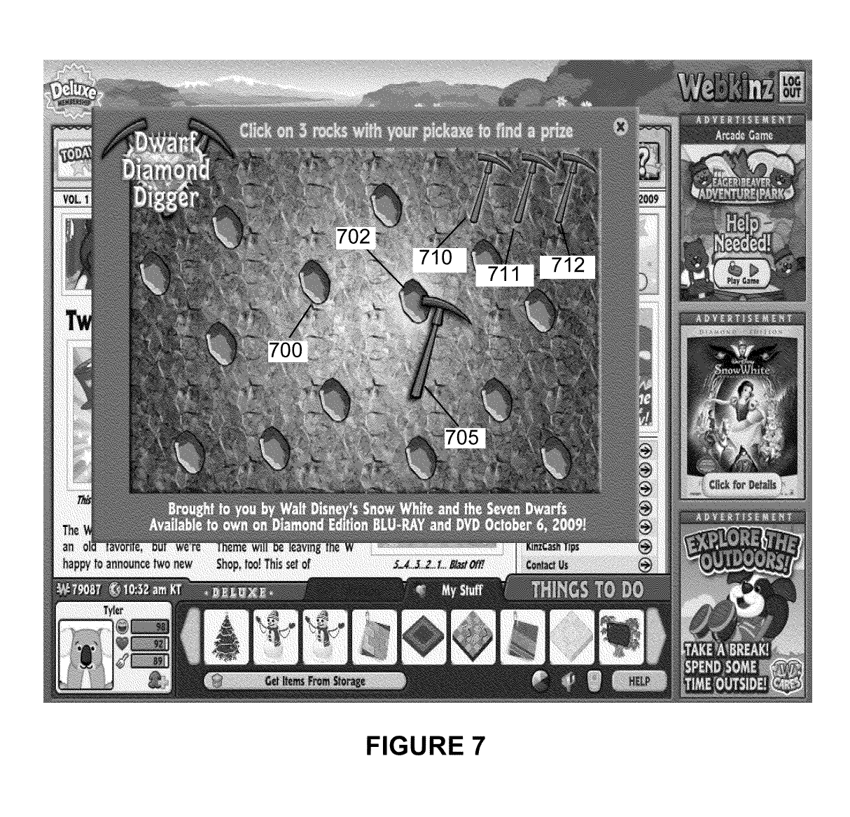

The user first executes the play button at 620, to start the game, shown in FIG. 7. In the FIG. 7 game, there are a number of different rocks shown at 700, 702 and others. The user can select any of those rocks using the cursor 705. The system switches the mouse cursor to a “pickaxe” icon 705.

This embodiment allows the user to select three different rocks, to try and find prizes under those rocks that can be provided at random, for example. FIG. 7 shows three similar pickaxe icons 710, 711, 712 to represent the number of tries that the user has remaining. Each the user selects a rock, one of the icons 710, 711, 712 disappears. In operation, therefore, the user selects one of the rocks. The system randomly selects and hides prizes in 9 of the 12 digging spots. This means there are 3 empty spaces, but the user is very likely to win a prize each time the user plays the game. To play, the user hovers the “pickaxe” cursor 705 over a digging spot within the mine. The system highlights the digging spot shown in 702, for example the highlight of a digging spot may be made brighter, or changed to a color such as yellow. The operating pickaxe animates in a “chipping” action to remove one of the rocks.

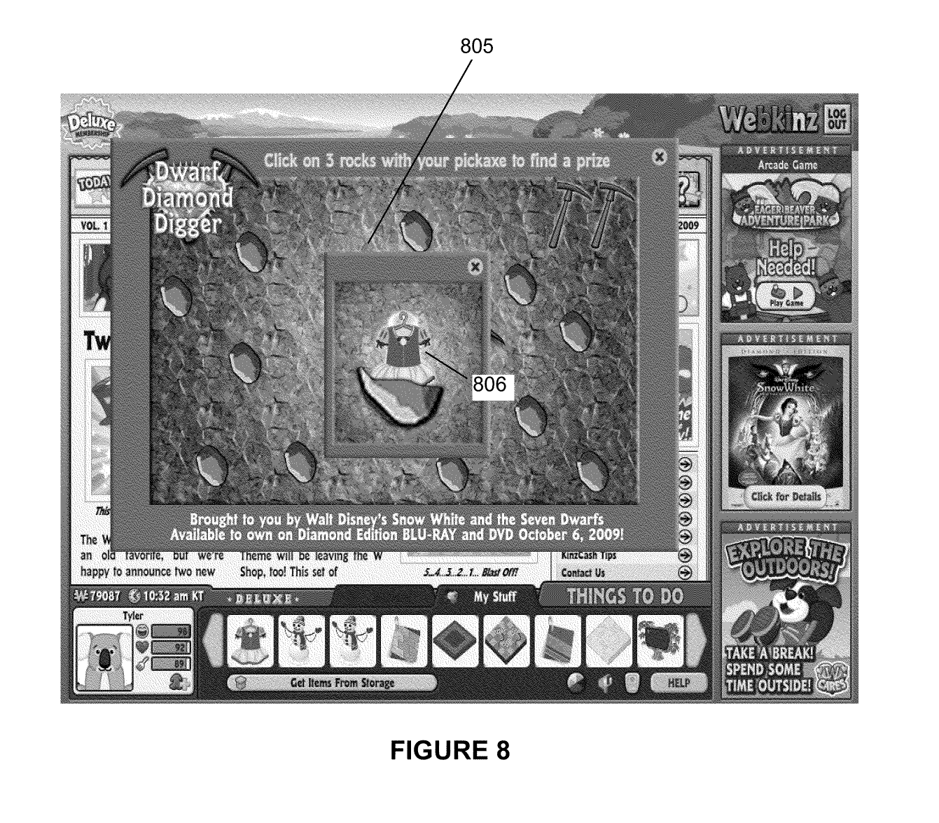

The system determines that the user has clicked on a digging spot with a prize and triggers an animation—within a mini popup in this embodiment—revealing what was buried under the rock as shown in FIG. 8. At this time, the system fades out one “counter pickaxe” 710, 711, 712 from the top of the Dwarf Diamond Digger interface thereby showing that the user has used one of three turns. The system adds the revealed prize to the user's dock.

The system also deactivates the first digging spot.

The user then hovers the “pickaxe” cursor over a second digging spot.

The system highlights the second digging spot.

The user clicks the second digging spot.

The pickaxe animates in a “chipping” action.

The system determines that the user has spotted a prize and triggers an animation (a popup) to reveal the second prize.

The system fades out the second “counter pickaxe” and deactivates the second digging spot.

The system adds the revealed prize to the user's dock.

The user clicks the [X] button to close the prize award mini popup.

The system closes the prize award mini popup and displays the Dwarf Diamond Digger interface.

A similar combination occurs for the third time: The user hovers the “pickaxe” cursor over a third digging spot; The system highlights the third digging spot; The user clicks the third digging spot; The pickaxe animates in a “chipping” action; The system determines that the user has spotted a prize and triggers an animation [in a popup] to reveal the third prize; The system fades out the third “counter pickaxe” and adds the revealed prize to the user's dock.

The user clicks the [X] button to close the prize award mini popup.

FIG. 8, for example, shows how, if the user uncovers a rock that has a prize, the prize window is revealed as 805. The reveal prize may, for example, include an animation and the item itself. The item itself may be a piece of virtual item like a piece of virtual clothes 806 that is related to the item to which the user selected. Here, the user has clicked on the Snow White game, and receives a prize item that is a virtual Snow White clothing item that can be used on any of the user's virtual pets so that the virtual pets are dressed like Snow White.

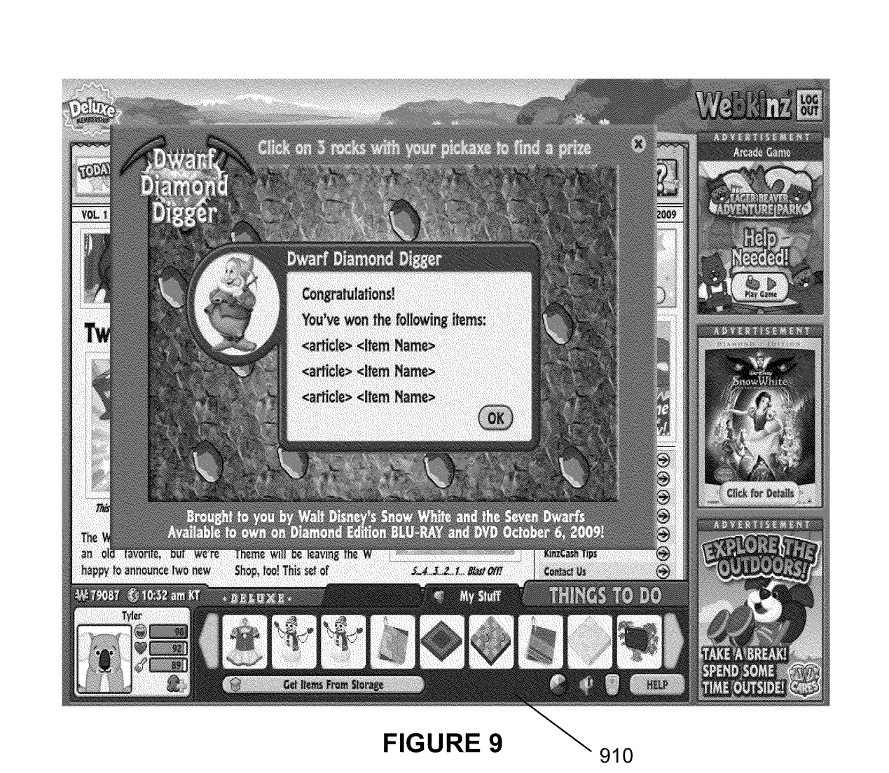

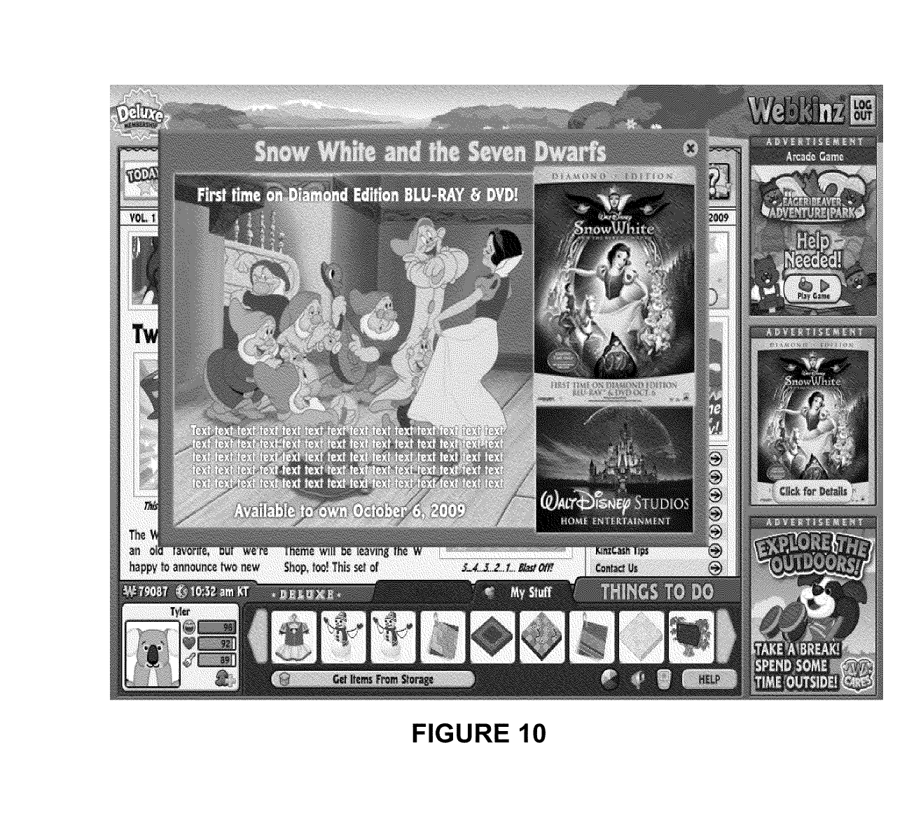

Once receiving a prize, the screen of FIG. 9 congratulates the user on winning that item. The user then exits the activities screen to enter the screen of FIG. 10 which shows the final ad message.

According to an embodiment, a statistical value is maintained for the rule 1121, wherein average number of gameplays per user or per click is carried out. For example, the user may get a gameplay randomly, or one time in each nine clicks. The value may be an adjustable value that can preset on the server by an administrator.

The system adds the revealed prizes to the user's dock shown as 910 in FIG. 9.

The user clicks the [X] button to close the prize award mini popup.

The prizes obtained under the rocks are usable in the Webkinz game as virtual items. These items can be stored associated with a user account, and therefore can be used by the user either indefinitely, or for some period of time specified by the game. Alternatively, a user might be able to transfer the items to another account or another user.

According to an embodiment, each ad can only be clicked once by a user, to avoid a user trying to click repeatedly to obtain bonus content. The click for details button 405 allows the user to click on the ad once. Once the user has clicked on and triggered either the ad or the additional content, the select button is removed at 1150. Another embodiment may allow the ad to be selected more than once, e.g., every day or once every visit, to encourage repeated visits and/or repeated exposure to the ads.

An important feature of this system is that it encourages users to actually view the ads and also to click on the ads. Rather than an advertisement being an annoyance, this scenario transforms the ads into a desired feature, and encourages the user to select the ad, knowing that the user has a chance of winning items that they might find valuable.

An alternative Scenario 1 is that the user clicks on empty digging spots with their 3 tries and gets no prize.

An Alternative Scenario 2 is that the user quits the Dwarf Diamond Digger game. This scenario extends from step 1 in the main scenario and can occur at any point during game play.

A number of prize items can be awarded, including:
Snow White dress (806),
Enchanted Mirror on the Wall (animated masked laughing face)
Diamond apple (presentable—sparkly animation)
Snow White black wig (with red bow)
“IOU 1 Kiss—Prince Charming” signed framed note (presentable)
Dwarf floppy hat
Dwarf white beard and glasses
Dwarf Diamond Digger wall plaque (crossed pickaxes)
Glass (coffin) coffee table
Dwarf jerkin shirt
Snow White slippers
Dwarf forest boots

All of these example items can have tie-ins to the existing item being advertised, although alternative items not related to the advertised item might be offered in some embodiments, such as where the advertiser does not want to grant legal permission for related items, for example.

Other bonuses can be prizes that are already for sale, such as items for sale in the W-shop.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other prizes can be obtained in this way.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, or computer, operating as either or both of the client or server computer. The computer can be part of a system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

The computer may include a processor that operates to accept user commands, execute instructions and produce output based on those instructions. The computer is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCl”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

A least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein.

This can operate on a computer system from a network server via communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

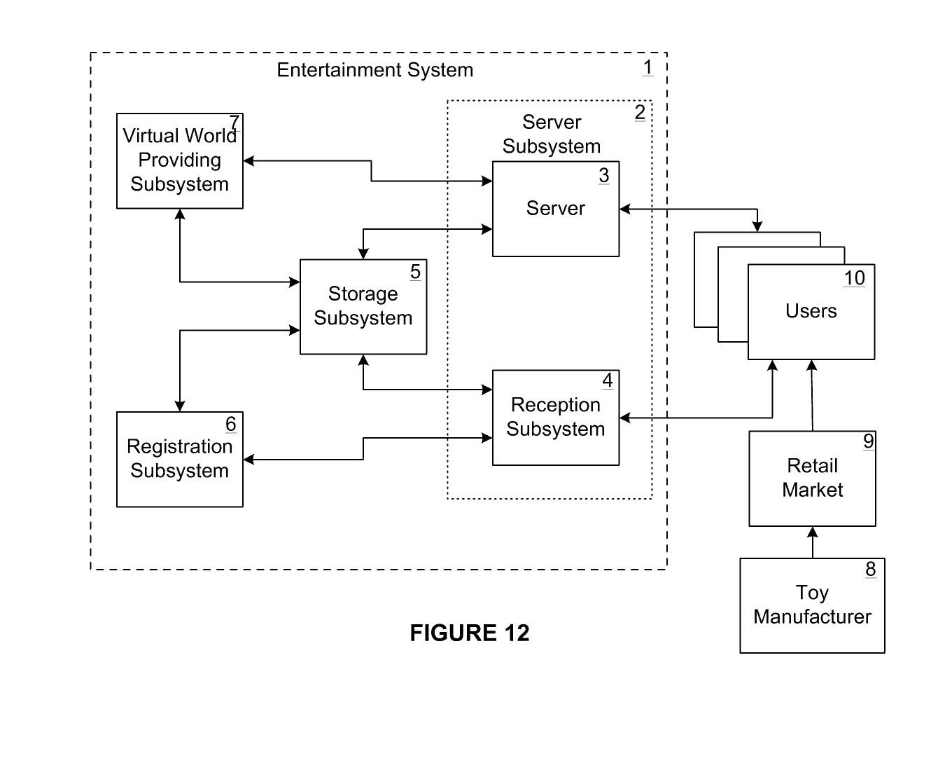

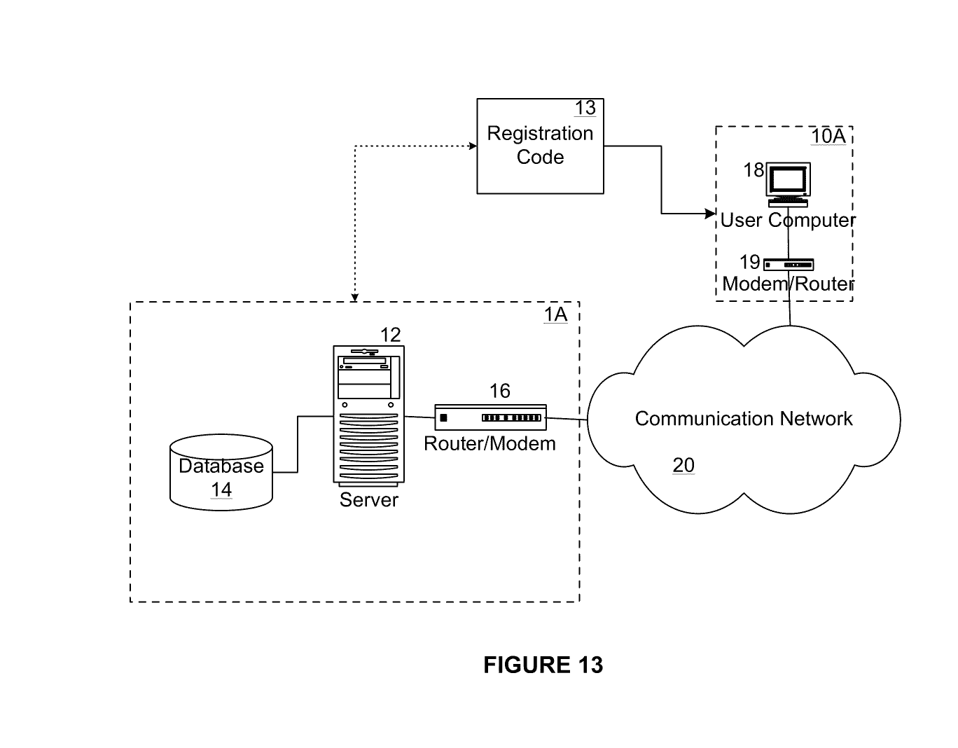

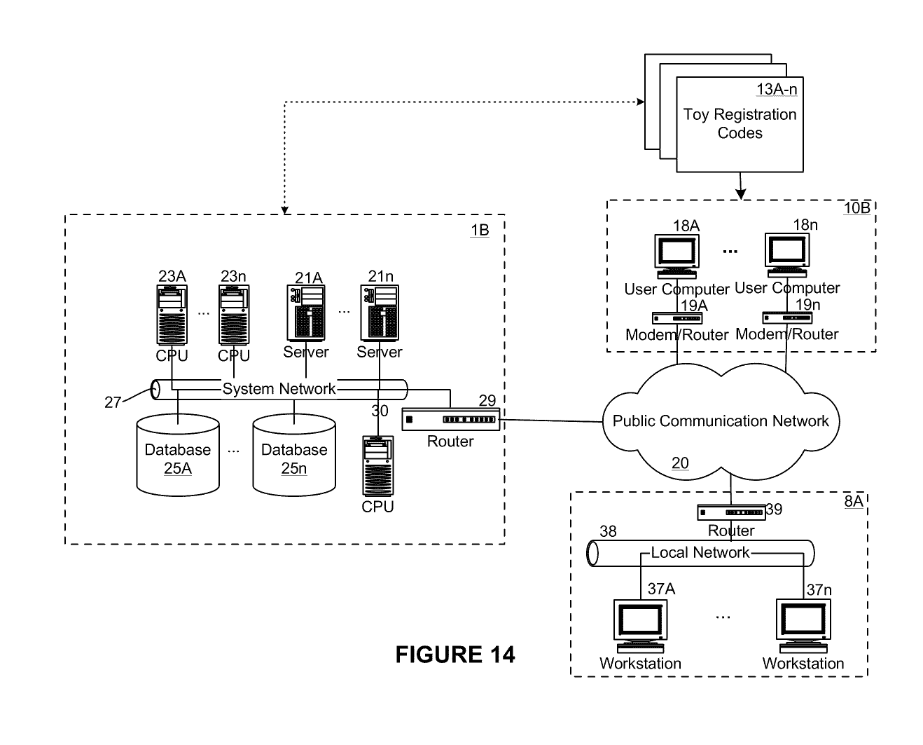

For example, An system for implementing one or more embodiments of the invention is shown in FIGS. 12 and 13, although other alternatives can also be provided by different configurations and/or alternative means that are known in the art.

FIG. 12 shows a top-level block diagram of an embodiment 1 for implementing one or more of the example embodiments interacting with various users 10. The users 10 should have previously purchased and registered one or more products (toys) from a Retail Merchant 9, who obtained the toys from a manufacturer 8, or via a distributor.

The Entertainment System 1 is comprised of a server subsystem 2 for interacting with the users 10 via a user computer being operated by the user. The server subsystem can utilize a server 3, for serving content, including web pages, data, commands, and/or programs, for example, to the user computer. In addition, the server subsystem can include a reception subsystem 4, for receiving information and commands from the users 10. Alternatively, the server 3 and reception subsystem 4 might be combined into a single computer application, such as a commercially available web server, for example, running on one or more computers. The current system uses commercially available computer applications, such as Windows Server to implement much of the server subsystem.

The example Entertainment System 1 also comprises a Storage Subsystem 5, for storing system data, user IDs and passwords, toy registration codes, personalized user information, etc. utilized by the various subsystems. The Storage Subsystem 5 of the current system will utilize a commercially available database application running on commercially available hardware, for example.

A Registration Subsystem 6 can be used for registering the user and the user's toy into the system, so that the user has access to restricted portions of the system. The Registration Subsystem 6 may utilize its own dedicated application and hardware, or could be combined with or share the Server Subsystem 2 applications and/or hardware. The registration subsystem examines the registration code against stored data relating to a plurality of registration codes each representing a toy for sale.

A Virtual World Providing Subsystem 7 generates and/or provides the virtual world data to be served by the server 3 to the users 10 for use in displaying a virtual world on the users' computers. This subsystem 7 can be used to generate the ads and for providing the bonus content discussed above. Portions of this data may be generated on the fly in response to user interactions, and portions are likely to be obtained and/or derived from data stored in the Storage Subsystem 5. (For example, in an example embodiment, items owned by the user (the items in the dock for example), the virtual room state (virtual furniture in the room for example), virtual cash, health, happiness, hunger parameters are all examples of “stored data”, whereas data generated on the fly include position in the room (which also gets stored), and Arcade Game scores, for example).

Again, the Subsystem 7 may utilize unique applications and/or hardware, or may be combined with one or more of the Registration Subsystem 6 and/or the Server Subsystem 2 applications and hardware.

FIG. 13 shows an embodiment 1A of the system 1, in one of its simplest forms. The system 1A comprises a server 12, a database 14, and a router/modem 16 to connect to a public communications network 20. A user 10A, utilizing a workstation 18, is also connected to the communications network via a router and/or modem 19, for example. In this implementation, the server 12, along with the database 14 and router/modem 16 and the appropriate software, implement all of the subsystem functions of the System 1 shown in FIG. 1 by executing various application programs on the server 12 hardware, for example. Of course, the system 1A may also support many additional users in a manner similar to that shown for user 10A, for example.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of operating a website, comprising:
in a server computer system, storing a user account with information indicative of items associated with a website user, said items usable on a website;
producing information from the server computer system indicative of the website, said information for displaying a virtual world;
accepting inputs which allowing interacting with said items in said virtual world;
producing at least one advertisement in an area associated with said virtual world as part of said information;
detecting a selection of said at least one advertisement by a user, and responsive to said detecting the selection, determining whether the selection is entitled to additional content, said determining comprising some times detecting that the selection is entitled to additional content and other times detecting that the selection is not entitled to additional content;
based on said detecting that the selection is not entitled to additional content, displaying advertisement content to the website user; and
based on said detecting that the selection is entitled to additional content, then displaying an activity to the user in place of said advertising content, where a said activity includes creating an additional item that is stored in said user account associated with the website user, said additional item being in addition to those items already stored in said user account, and said additional item being usable on the website,
wherein said additional item creates a look on the website that is indicative of a content of the advertisement, and wherein said additional item is stored in said user account and is usable at a time after completing said activity.

2. A method as in claim 1, wherein said information which displays a virtual world shows items that are uniquely associated with a user, where said items include virtual pets, and also includes items that are usable by said virtual pets.

3. A method as in claim 2, wherein said items usable by said virtual pets include clothing.

4. A method as in claim 3, wherein said additional item created by said additional content is clothing that is associated with the content of the advertisement.

5. A method as in claim 1, further comprising after said detecting a selection, changing an output which creates said one advertisement in a way that prevents said one advertisement from being again selected by the user.

6. A method as in claim 1, wherein said activity is a game which has prizes from success in the game, said prizes being said additional item that can be used on the website.

7. A method as in claim 1, further comprising setting a rule which defines a statistic indicating a likelihood of whether the user will be entitled to said additional content.

8. A method as in claim 3, wherein said advertisement is about a movie, and said clothing comprises clothing that looks the same as clothing used within the movie.

9. A method of using a website, comprising:
in a client computer, requesting information from a remote user account, said information being indicative of items associated with a website user, and where said items are usable on a website;
displaying a virtual world on the client computer, said virtual world including said items from said remote user account;
from said client computer, interacting with said items in said virtual world;
viewing at least one advertisement in an area associated with said virtual world as part of said information;
selecting said at least one advertisement on the client computer;
responsive to said selecting, at one time displaying an advertisement;
responsive to said selecting, at a different time, displaying an advertisement determining whether the selection is entitled to additional content, said determining comprising some times detecting that the selection is entitled to additional content and other times detecting that the selection is not entitled to additional content;
based on said detecting that the selection is not entitled to additional content, viewing advertisement content; and
based on said detecting that the selection is entitled to additional content, carrying out an activity in place of said advertising content, where said activity includes obtaining an additional item and storing said additional item in said user account associated with the website user, said additional item being beyond those items already stored in said user account, and said additional item being usable on the website,
subsequent to said activity, interacting with an item on said client computer which item includes said item combined with said additional item.

10. A method as in claim 9, wherein said virtual world displays items that are uniquely associated with a user, where said items include virtual pets, and also includes items that are usable by said virtual pets.

11. A method as in claim 10, wherein said items usable by said virtual pets include clothing that can be worn by said virtual pets.

12. A method as in claim 11, wherein said additional item created by said additional content is clothing that is associated with the content of the advertisement.

13. A method as in claim 11, wherein said advertisement is about a movie, and said clothing comprises clothing that looks like clothing used within the movie.

14. A method as in claim 9, wherein said some times detecting that the selection is entitled to additional content and other times detecting that the selection is not entitled to additional content is carried out randomly.

15. A method as in claim 9, wherein said some times detecting that the selection is entitled to additional content and other times detecting that the selection is not entitled to additional content is carried out by selecting 1 out of every n selections, wherein n is an integer greater than 1.

16. A server computer system, comprising:
a memory, storing information indicative of multiple different user accounts, each user account having information indicative of items associated with a website user, said items usable on a web site;
said server computer system producing information from the server computer indicative of the website, said information displaying a virtual world;
said server computer system accepting inputs which allowing interacting with said items in said virtual world;
said information including at least one advertisement in an area of a display associated with said virtual world as part of said information;
said server computer system detecting a selection of said at least one advertisement by a user, and responsive to said detecting the selection, determining whether the selection is entitled to additional content, said determining comprising some times detecting that the selection is entitled to additional content and other times detecting that the selection is not entitled to additional content;
said server computer system, based on said detecting that the selection is not entitled to additional content, providing advertisement content for display to the user;
said server computer system, based on said detecting that the selection is entitled to additional content, then providing an activity to the user in place of said advertising content, where said activity includes creating an additional item that is stored in said user account associated with the website user, said additional item being beyond those items already stored in said user account, and said additional item being usable on the website,
wherein said additional item creates a look on the website that is associated with a content of the advertisement, and wherein said additional item is stored in said user account and is usable at a time after completing said activity.

17. A computer system as in claim 16, wherein said some times detecting that the selection is entitled to additional content and other times detecting that the selection is not entitled to additional content is carried out randomly.

18. A computer system as in claim 16, wherein said some times detecting that the selection is entitled to additional content and other times detecting that the selection is not entitled to additional content is carried out by selecting 1 out of every n selections, where n is an integer greater than 1.

19. A computer system as in claim 16, wherein said information which displays a virtual world shows items that are uniquely associated with a user, where said items include virtual pets, and also includes items that are usable by said virtual pets.

20. A computer system as in claim 19, wherein said items usable by said virtual pets include clothing.

21. A computer system as in claim 20, wherein said additional item created by said additional content is clothing that is associated with the content of the advertisement.

22. A computer system as in claim 16, further comprising after said detecting a selection, changing an output which creates said one advertisement in a way that prevents said one advertisement from being again selected by the user.

23. A computer system as in claim 16, wherein said activity is a game which has prizes from success in the game, said prizes being said additional items that can be used on the website.

24. A computer system as in claim 16, further comprising storing a rule which defines a statistic indicating a likelihood of whether the user will be entitled to said additional content, and enabling changing said likelihood.

25. A computer system as in claim 21, wherein said advertisement is about a movie, and said clothing comprises clothing that looks the same as clothing used within the movie.

26. A method comprising:
providing virtual world data over a network to a plurality of user computers, said virtual world data for displaying a virtual world on the user computers;
providing advertising data to the user computers over the network, said advertising data for displaying an advertisement in said virtual world;
accepting inputs from the user computers for allowing selection of the advertisement on the user computers; and
in response to said selection of said advertisement on a first subset of said plurality of user computers including most, but not all, of said plurality of user computers, providing, based on a computer program, first content to said first subset of user computers, wherein said first content includes advertising information related to said advertisement;
in response to said selection of said advertisement on a second subset of said plurality of user computers including user computers not in said first subset of user computers, providing, based on said computer program, second content to said second subset of user computers, wherein said second content includes bonus content not provided in said first content, said bonus content including an activity in said virtual world for user participation.

27. The method of claim 26, wherein said activity has subject matter related to the subject of said advertisement.

28. The method of claim 27, wherein said bonus content includes providing a virtual item in response to said activity.

29. The method of claim 28, wherein said virtual item is of an image indicative of the subject matter of said advertisement.

30. The method of claim 26, wherein said computer algorithm randomly chooses the user computers contained in said first subset and said second subset.
